(19) United States
(12) Patent Application Publication
(10) Pub. No.: US 2010/0095197 A1
(43) Pub. Date: Apr. 15, 2010

(54) SYSTEM AND METHOD FOR DYNAMIC CONTENT PUBLISHING

(75) Inventors: Stephan Klevenz, Heidelberg (DE); Martin Hermes, Muehlhausen (DE); Matthias Rinck, Klingenmuenster (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 12/250,194

(22) Filed: Oct. 13, 2008

(51) Int. Cl. G06F 17/00

(52) U.S. Cl. 715/234

(57) ABSTRACT

This disclosure provides various embodiments of software and systems for integrating static and dynamic content for an instance of a web page. In one aspect, the software identifies a content repository of structured dynamic content associated with information for a web page comprising unstructured static content. The software inserts a metadata data structure defining a set of the structured dynamic content into the unstructured static content of the web page to create a tag-enriched web page. The software can further perform a publish process for the tag-enriched web page comprising querying the content repository for the set of structured dynamic content information defined by the metadata data structure, populating the metadata-enriched web page with the results of the publish process query, and storing the updated web page at a web server.

### TECHNICAL FIELD

The present disclosure relates to methods and software for network applications, such as web content management systems, and, more particularly, to methods and software for seamlessly integrating dynamic information into static web pages at design-time.

### BACKGROUND

Web content management (WCM) systems and applications provide authoring tools designed to allow users to create and manage web-based content. Some WCM systems use a database or other content repository to store content, metadata, and/or other information that may be needed by the WCM system. Further, some WCM systems offer intuitive or easy-to-understand functionally and operations that allow non-technical users to create or modify websites with little to no training.

In general, WCM systems are used to manage and control large, dynamic collections of web-based material (e.g., Hypertext Markup Language (HTML) documents, PHP documents, images, etc.). A WCM system generally facilitates document control, editing, and timeline management. For instance, a typical WCM system can provide one or more of the following features: automated templates, easily editable content, workflow management, document management, and content virtualization, among others. Using a WCM system can provide developers with tools that allow for the creation of attractive and well-designed web pages and/or websites with uniform or related layouts.

In many instances, developers may want to add dynamic functionality to a web page created using a WCM system. For example, static web pages created by WCM systems may be integrated with dynamic content, such as product pricing or inventory information. In some instances, the web pages initially created by the WCM system may be purely static, such that all information initially created for the web page remains the same until manually changed by a user or the WCM system. Web pages incorporating dynamic elements (i.e., the price of a product) can be created based on active templates such as JavaServer Pages (JSPs), in which static and unstructured content is inserted into the web page based on various operations performed at runtime. For instance, the dynamic content of the web page is part of the JSP template and is resolved during runtime through queries to a back-end repository using a web service, database query, Enterprise Java Bean (EJB), or another suitable method. In other words, at least a portion of the actual content for a web page incorporating a JSP template (or another suitable dynamic web page solution) is based on information retrieved from one or more runtime operation performed at the time when the page is requested. Thus, when the JSP page is published to a web server, the web page initially comprises static content generally defining the presentation and layout of the page, as well as some static content that will remain unchanged, and some active component such as a web service call that determines its portion of the web page only when the page is served in response to a user request.

While dynamic web pages such as JSPs provide for enhanced and up-to-date web pages, the effect of multiple dynamic page requests or a plurality of requests for a particular dynamic web page may have a negative performance impact on the web server or the other systems providing and supporting the dynamic aspects of the web page. For instance, a dynamic web page for a consumer products retailer may include, for example, twenty (20) products, each product associated with a static product description and a dynamic portion operable to determine the price and availability of the product at runtime. When a new user requests access to the page, the web server may perform each of the twenty (20) separate web service calls in order to retrieve all of the dynamic information required to complete the page. Further, multiple requests for the same dynamic web page by a single user may require repeated web service calls, or in some cases, require complex caching techniques and processing to avoid experiencing the performance degradation generally caused by multiple dynamic components. In systems with a medium to large number of user (or, in some cases, only a few users), performance and scalability issues may result from repeated runtime processing that must be performed each time a page is served, thereby increasing the processing load placed on the various production systems.

### SUMMARY

This disclosure provides various embodiments of software and systems for integrating static and dynamic content for an instance of a web page. In one aspect, the software identifies a content repository of structured dynamic content associated with information for a web page comprising unstructured static content. The software inserts a metadata data structure defining a set of the structured dynamic content into the unstructured static content of the web page to create a tag-enriched web page. The software can further perform a publish process for the tag-enriched web page comprising querying the content repository for the set of structured dynamic content information defined by the metadata data structure, populating the metadata-enriched web page with the results of the publish process query, and storing the updated web page at a web server.

While generally described as software, some or all of the aspects or techniques may be further included or implemented in respective systems or other devices for executing or implementing dynamic content publishing. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1A illustrates a software environment capable of seamlessly integrating dynamic information into a web page at design-time according to a particular implementation of the present disclosure.

FIG. 1B is a block diagram providing a detailed illustration of the software environment of FIG. 1A.

FIG. 2A is a flowchart illustrating one example of the steps for generating a web page that will integrate dynamic content from a content repository at design-time from the perspective of a web content management system in accordance with the illustrated environment of FIGS. 1A and 1B.

FIG. 2B is a flowchart illustrating one example of the steps for publishing the web page wherein dynamic information from the content repository is integrated into the web page at design-time from the perspective of the web content management system in accordance with the illustrated environment of FIGS. 1A and 1B.

FIG. 2C is a flowchart illustrating one example of the steps for republishing the web page with updated dynamic information from the content repository after an initial publishing of the web page from the perspective of the web content management system in accordance with the example environment of FIGS. 1A and 1B.

FIG. 3 is a flowchart illustrating one example of the steps for generating a web page that integrates static content and dynamic information from a content repository at design-time using the web content management system from the perspective of a web developer within the example environment of FIGS. 1A and 1B.

FIG. 4 is an example signaling and flow diagram illustrating the interaction of two clients with the software environment, the first client viewing a first version of a web page, and the second client viewing a second version of the web page after modifications are made to the content repository storing the dynamic information integrated into the web page in accordance with the example environment of FIGS. 1A and 1B.

FIGS. 5A-5J illustrate one particular embodiment of the graphical user interface (GUI) provided by the web content management system to web developers to create web pages that can integrate dynamic information from the content repository at design-time in accordance with the flowchart of FIG. 3 and the example environment of FIGS. 1A and 1B.

### DETAILED DESCRIPTION

This disclosure generally describes software, methods, and systems for seamlessly integrating dynamic information stored in one or more content repositories into a web page. This integration can occur once at publishing without requiring multiple instances of data retrieval when the web page is requested by multiple clients. To do so, a web content management system (WCMS) (or another appropriate application) such that one or more metadata data structures (e.g., dynamic tags or metatags) can be embedded or otherwise inserted into the web page, where the metadata data structures define or refer to a set of dynamic information stored in one or more content repositories, such as a database. The WCMS can then publish the web page to a runtime system, such as a production web server or networked application server, where one or more users can access the page. This accessed page can quickly provide up-to-date information without requiring a further query to the back-end systems. To integrate the dynamic information, during the publish process, and prior to sending the web page to the production web server, the WCMS analyzes the metadata data structures inserted into the web page, performs one or more queries to the content repositories associated with the metadata data structures, and replaces the metadata data structures with the dynamic information returned from the queries. The updated or populated web page, which now includes the integrated dynamic information in a static form, then comprises primarily, and sometimes solely, static content. That static web page is then sent to and stored at the production web server for clients to request and users to view.

In various configurations that integrate the dynamic information as a part of the static content of the published web page, the production web server can simply return the static web page to users requesting the page. In those circumstances, processing by the web server and by the database server can be greatly diminished, particularly at run-time in a production environment, as is the internal network bandwidth usage because the dynamic queries are reduced or eliminated. Put differently, this can reduce the number of queries from the web server to the back-end server, as well as reduce the delay experienced on the front-end as those queries are no longer executed prior to serving or fully populating the page. As such, the production web server need not perform the additional processing typically associated with dynamic web pages and can use the now-free resources to provide a more stable and efficient web server. If the dynamic information of the one or more content repositories associated with the published web page is modified after the web page has been published, the WCMS can easily republish the web page by performing its publishing process again, and retrieving and integrating the updated dynamic information into the web page as static content, and resending the updated web page to the production web server. Thus, the production web server is decoupled from the normal performance requirements and limitations typically associated with dynamic web pages, while still providing up-to-date dynamic information to clients in a seamless integration.

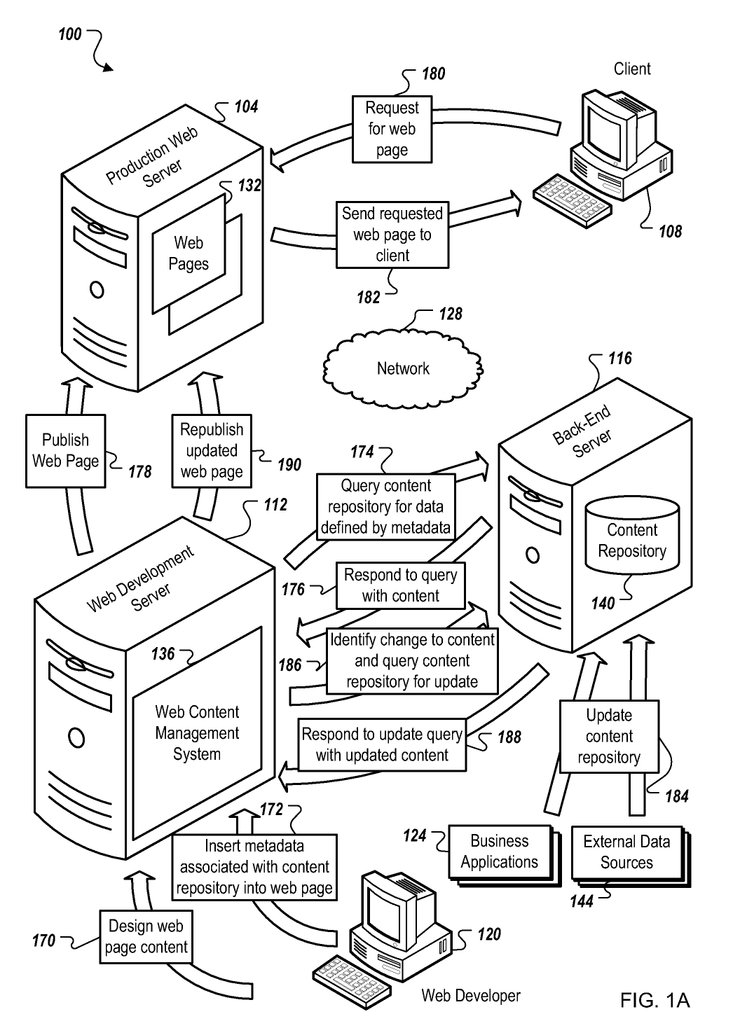

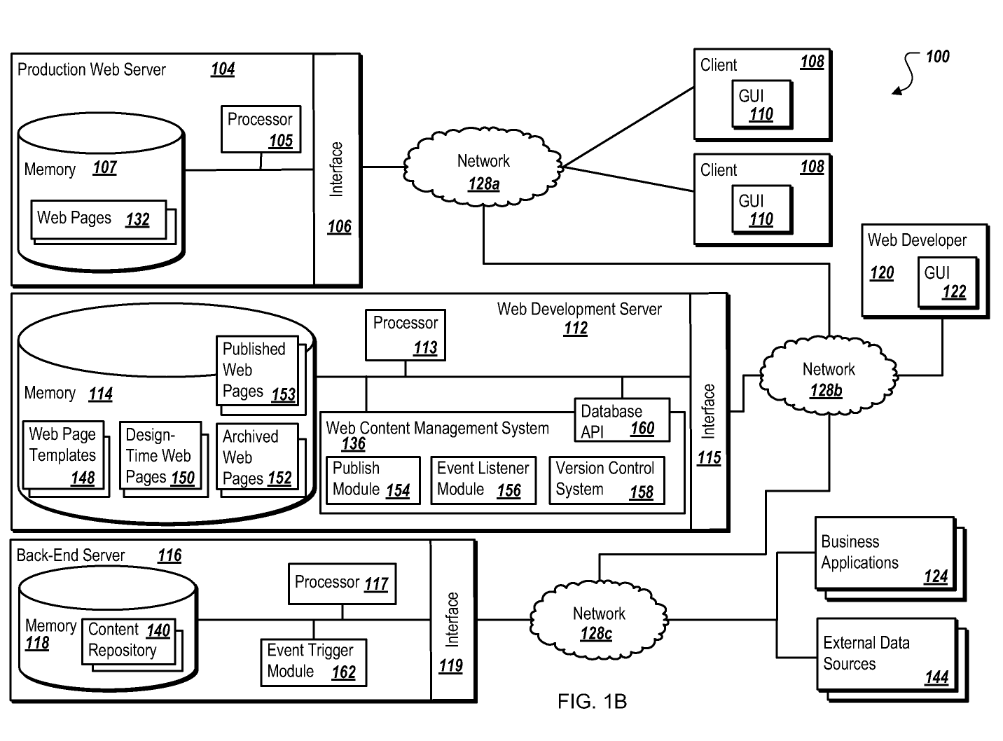

Turning to the example implementation of FIGS. 1A and 1B, the illustrated software environment 100 includes, or is communicably coupled with, one or more clients 108, a production web server 104, a web development server 112, a back-end server 116, a web developer 120, one or more business applications 124, one or more other external data sources 144, and a network 128. Each of the servers 104, 112, and 116 comprise electronic computing devices operable to receive, transmit, process, store, or manage data and information associated with the software environment 100. As used in this document, the term “computer” is intended to encompass any suitable processing device. For example, the environment 100 may be implemented using computers other than servers, including a server pool. Further, any, all, or some of the servers 104, 112, and 116 may be adapted to execute any operating system, including Linux, UNIX, Windows Server, or any other suitable operating system. In the illustrated embodiment, the production web server 104 is a web server used to provide web pages via the network 128 to the one or more clients 108, as well as other users external to environment 100. It will be understood that the term “web server” can include any suitable component or module for providing or serving networked pages, such as networked business applications and such. The production web server 104 may also include or be communicably coupled with a mail server, while either or both of the web development server 112 or the back-end server 116 may include or be communicably coupled with a web server and/or a mail server.

In the present implementation, and as shown in FIG. 1B, the production web server 104, the web development server 112, and the back-end server 116 each include an interface (106, 115, and 119, respectively), a processor (105, 114, and 117, respectively), and a memory (107, 114, and 118, respectively). The interfaces 106, 115, and 119 are used for communicating with other systems in a client-server or other distributed environment (including within environment 100) connected to the network 128, for example the one or more clients 108, the web developer 120, or any of the other illustrated servers. Generally, each interface 106, 115, and 119 comprises logic encoded in software and/or hardware in a suitable combination and operable to communicate with the network 128. More specifically, the interfaces 106, 115, and 119 may comprise software supporting one or more communication protocols associated with communications such that the network 128 or hardware is operable to communicate physical signals within and outside of the illustrated software environment 100.

Generally, the network 128 facilitates wireless or wireline communications between the components of the software environment 100 (i.e., between the production web server 104 and the web development server 112, the web development server 112 and the back-end server 116, the web developer 120 and the web development server 112, the clients 108 and the production web server 104, as well as between the other components as appropriate), as well as with any other local or remote computer, such as those associated with the one or more business applications 124 or external data sources 144. The network 128 is illustrated as a single network in FIG. 1A, and as three separate networks (128a, 128b, and 128c) in FIG. 1B. In any implementation, the network 128 may be a continuous or discontinuous network without departing from the scope of this disclosure, so long as at least a portion of the network 128 may facilitate communications between senders and recipients. The network 128 may be all or a portion of an enterprise or secured network. As an example, in FIG. 1B networks 128b and 128c may represent a portion of an enterprise network, while network 128a may represent a connection to the Internet. In some instances, a portion of the network 128 may be a virtual private network (VPN), such as, for example, the connection between the web developer 120 and the web development server 112. All or a portion of the network 128 can comprise either a wireline or wireless link. Example wireless links may include 802.11a/b/g/n, 802.20, WiMax, and/or any other appropriate wireless link. In other words, the network 128 encompasses any internal or external network, networks, sub-network, or combination thereof operable to facilitate communications between various computing components inside and outside the illustrated environment 100. The network 128 may communicate, for example, Internet Protocol (IP) packets, Frame Relay frames, Asynchronous Transfer Mode (ATM) cells, voice, video, data, and other suitable information between network addresses. The network 128 may also include one or more local area networks (LANs), radio access networks (RANs), metropolitan area networks (MANs), wide area networks (WANs), all or a portion of the Internet, and/or any other communication system or systems at one or more locations.

Each of the example servers 104, 112, and 116 also includes a processor (105, 114, 117, respectively). Each processor 105, 113, and 117 executes instructions and manipulates data to perform the operations of the associated server 104, 112, and 116, and may comprise, for example, a central processing unit (CPU), a blade, an application specific integrated circuit (ASIC), or a field-programmable gate array (FPGA), among other suitable options. Although each processor 105, 113, and 117 is illustrated as a single processor, multiple processors may be used according to the particular needs of the associated server. References to a single processor 105, 113, or 117 are meant to include multiple processors where applicable. The operations that each processor 105, 113, and 117 executes are determined by the purpose and operations of its associated server.

Each of the example servers 104, 112, and 116 also includes a memory (107, 114, and 118, respectively). Each memory may include any memory or database module and may take the form of volatile or non-volatile memory including, without limitation, magnetic media, optical media, random access memory (RAM), read-only memory (ROM), removable media, or any other suitable local or remote memory component. Each memory may store various objects or data, including classes, frameworks, applications, backup data, business objects, jobs, web pages, web page templates, database tables, content repositories storing business or other dynamic information, or other information including any parameters, variables, algorithms, instructions, rules, constraints, or references thereto relevant to the purposes of the particular server. Each memory may also include any other appropriate data, such as VPN applications, firmware logs and policies, firewall policies, a security or access log, print or other reporting files, as well as others. Again, the particular data stored in each memory 107, 114, and 118 will be described in detail below along with the further description of the related server.

The production web server 104 is any web server that stores one or more web pages 132 in memory 107, where at least a portion of the web pages 132 can be communicated to users or clients in a production environment. Specifically, the production web server 104 is responsible for receiving hypertext transfer protocol (HTTP) requests from one or more clients 108 (arrow 180) for one or more web pages 132 and responding to the requests by serving, or sending, the requested web pages 132 to the requesting client 108 via an HTTP response (arrow 182). For example, these clients may be internal users, external or third party customers, automated applications, and so forth. At least some of the web pages 132 stored at the production web server 104 are received from a publish process performed at or by the web development server 112 and the development server's WCMS 136 (arrow 178). Updates to and new versions of stored web pages 132 are also received from the web development server 112 (arrow 190) as the WCMS 136 performs its republish process. In some instances, prior versions of the stored web pages 132 may be overwritten on the web server 104, while in other instances, older versions of the web page 132 may be archived while remaining accessible to clients 108 and other users. The production web server's processor 105 executes the functionality required to receive and respond to the web page requests, as well as those required to store the web pages 132 provided by the web development server 112.

The illustrated implementation of FIGS. 1A and 1B includes one or more local and/or remote clients 108. The client 108 is any computing device operable to connect or communicate at least with the production web server 104 and/or the network 128 using a wireline or wireless connection. Each client 108 includes a GUI 110. In general, the client 108 comprises an electronic computing device operable to receive, transmit, process, and store any appropriate data associated with the software environment of FIGS. 1A and 1B. It will be understood that there may be any number of clients 108 associated with environment 100, as well as any number of clients 108 external to environment 100. For example, environment 100 may include a single client as illustrated in FIG. 1A, or two or more clients 108 as illustrated in FIG. 1B. Further, there may be additional clients 108 external to the illustrated portion of environment 100 that are capable of interacting with the environment 100. Further, the term “client” and “user” may be used interchangeably as appropriate without departing from the scope of this disclosure. Moreover, while each client 108 is described in terms of being used by one user, this disclosure contemplates that many users may use one computer or that one user may use multiple computers. As used in this disclosure, the client 108 is intended to encompass a personal computer, touch screen terminal, workstation, network computer, kiosk, wireless data port, smart phone, personal data assistant (PDA), one or more processors within these or other devices, or any other suitable processing device. For example, the client 108 may comprise a computer that includes an input device, such as a keypad, touch screen, mouse, or other device that can accept information, and an output device that conveys information associated with the operation of the production web server 104 (or other servers in environment 100) or the client 108, including digital data, visual information, or the GUI 110. Both the input device and the output device may include fixed or removable storage media such as a magnetic computer disk, CD-ROM, or other suitable media to both receive input from and provide output to users of the clients 108 through the display, namely the GUI 110.

The GUI 108 comprises a graphical user interface operable to allow the user to interface with at least a portion of environment 100 for any suitable purpose, including allowing a user to view one or more web pages 132 received by the client 108 from the production web server 104. Generally, the GUI 110 provides users with an efficient and user-friendly presentation of data provided by or communicated within the system. The term “graphical user interface,” or GUI, may be used in the singular or in the plural to describe one or more graphical user interfaces and each of the displays of a particular graphical user interface. Therefore, the GUI 110 can be any graphical user interface, such as a web browser, touch screen, or command line interface (CLI) that processes information in the environment 100 and efficiently presents the results to the user. In general, the GUI 110 may include a plurality of user interface (UI) elements such as interactive fields, pull-down lists, and buttons operable by the user at the client 108. These UI elements may be related to the functions of one or more applications executing at the client 108, such as a business application or web browser.

In the particular implementation of FIGS. 1A and 1B, the GUI 110 comprises a web browser that allows users to view and interact with the one or more web pages 132 stored at the production web server 104. Example web browsers associated with the GUI 110 may include Microsoft's Internet Explorer, Mozilla's Firefox, Apple's Safari, Opera, and Google's Chrome, as well as any other suitable browser. In the present implementation, the production web server 104 receives requests from the client's web browser for one or more web pages 132, and responds by sending the requested web page 132 to the client 108 via the network 128.

The web development server 112 represents a development server providing web developers 120 with a non-production, design-time server for the design and development of web pages and web page templates. Additionally, the web development server 112 allows developers 120 and other users to design web pages that integrate the dynamic information from one or more content repositories. As shown in both FIGS. 1A and 1B, the web development server 112 includes a WCMS 136. At a high level, the WCMS 136 is an application or framework used by web developers 120 to create and manage web-based content, where the WCMS 136 includes the functionality for content creation, content control, editing of previously-created content, and other web page design and management processes. In some instances, portions of the WCMS 136 may be stored, referenced, or executed remotely. For example, a portion of the WCMS 136 may be a web service that is remotely called be external users and/or other applications, while another portion of the WCMS 136 may be a remote client application (not shown) stored at the web developer 120 or one or more of the clients 108. In other instances, at least a portion of the WCMS 136 may be accessed or administered through web browser-based interfaces available to web developers 120 and/or clients 108 through a particular web portal or address. Moreover, the WCMS 136 may be a child or sub-module of another software module or enterprise application (not shown) without departing from the scope of this disclosure. Regardless of the particular implementation, “software” may include software, firmware, wired or programmed hardware, or any combination thereof as appropriate on tangible computer-readable media. Indeed, each software component may be fully or partially written or described in any appropriate computer language including C, C++, Java, Visual Basic, assembler, Perl, ABAP, any suitable version of 4GL, a proprietary computer language, or any other suitable language. The WCMS 136 can be used to create and store web page templates 148, design-time web pages 150, archived web pages 152 representing a published web page 132 with its static content and the explicit metadata data structures inserted prior to publishing, and a set of published web pages 153 representing the published web pages integrating both static content and dynamic information by replacing the metadata data structures of the web page with dynamic information received during the WCMS's 136 publish process. The web page templates 148 may be stored as text files, HTML files, eXtensible Markup Language (XML) files, PHP files, or any appropriate format that provides static content to be included in the designed web pages. Design-time web pages 150 and the archived web pages 152 can also be stored in any appropriate format that is readable and modifiable by users via the WCMS 136, while the published web pages 153 can be stored in the format that the WCMS 136 publishes them to during the publish process.

Importantly, the WCMS 136 provides web page designers with the ability to insert metadata data structures, such as metatags, into design-time web pages 150, where the metadata data structures define certain dynamic information stored in one or more content repositories 140. During the web page's design, the metadata data structures are inserted into particular locations within the design-time web page 150 to identify where dynamic information is to be added. Dynamic information can be added from the one or more content repositories stored in the back-end server 116, as well as from other locations associated with or identified by the WCMS 136. The metadata data structure inserted into a web page 150 can often provide the WCMS 136 with information representing the appropriate content repository 140 to query and the appropriate location within the content repository 140 itself where the desired dynamic information defined by the metadata can be retrieved. For example, the WCMS 136 may automatically identify the appropriate content repository 140 according to the metadata data structure or according to internal or known business logic using the metadata data structure. In this example, a metadata data structure inserted into a design-time web page 150 by the WCMS 136 can identify a particular field located in a particular content repository 140, as well as the logical identifier or address of that repository, stored in the back-end server 116 to be added to the web page. Until the design-time web page 150 is published (or republished) by the WCMS 136 and stored as a web page 132 at the production web server 104 (arrows 178 and 190 in FIG. 1A), the metadata data structure remains part of the web page's design. If the designer elects to preview the web page's design prior to publishing using a virtual web server or preview functionality of the WCMS 136, a placeholder image can be included where the metadata data structure is located to indicate the data structure's presence within the web page design. In some situations, the data structure and placeholder can be replaced in the design-time web page 150 after it is published or during its publication. In other circumstances, the metatag may remain within the webpage even after publishing has populated the webpage with the dynamic information.

The software environment 100 can include one or more web developers 120. At a high level, each web developer 120 comprises an electronic computing device operable to receive, transmit, design, update, and modify one or more web pages created using the WCMS 136 of the web development server 112 using a wireline or wireless connection (arrow 170). Additionally, the web developer 120 can use the WCMS 136 to identify the location within a web page where dynamic information should be inserted, and to insert the appropriate metadata data structure from a content repository 140 into the design of a web page for later integration (arrow 172). Although each web developer 120 is described in terms of being used by or associated with a single user, this disclosure contemplates that multiple users may use or be associated with one web developer 120, or that one user may use multiple web developers 120. In other words, an individual user or a team of users may be represented by a single web developer 120. Similar to the client 108, the web developer 120 is intended to encompass a personal computer, touch screen terminal, workstation, network computer, kiosk, wireless data port, smart phone, personal data assistant (PDA), one or more processors within these or other devices, or any other suitable processing device. For example, the web developer 120 may comprise a computer that includes an input device that can accept information from one or more users and an output device that conveys information associated with the operation of the web development server 112 and the WCMS 136, including digital data and visual information representing one or more web pages, as well as a GUI 122. Both the input device and the output device may include fixed or removable storage media such as a magnetic computer disk, CD-ROM, or other suitable media to both receive input from and provide output to users of the web developer 120 through the display, namely the GUI 122.

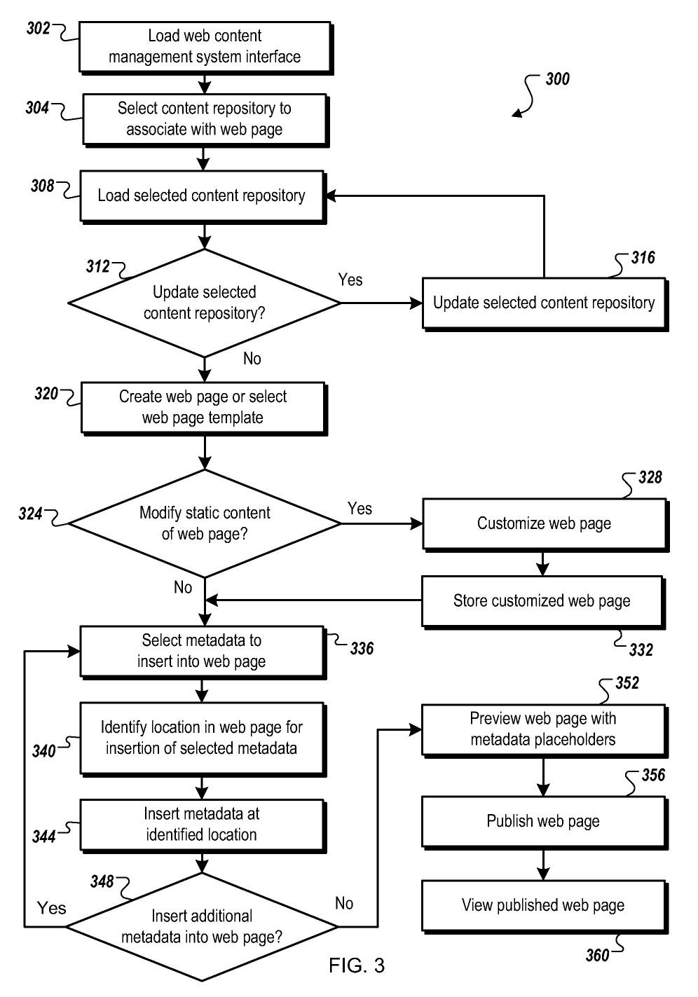

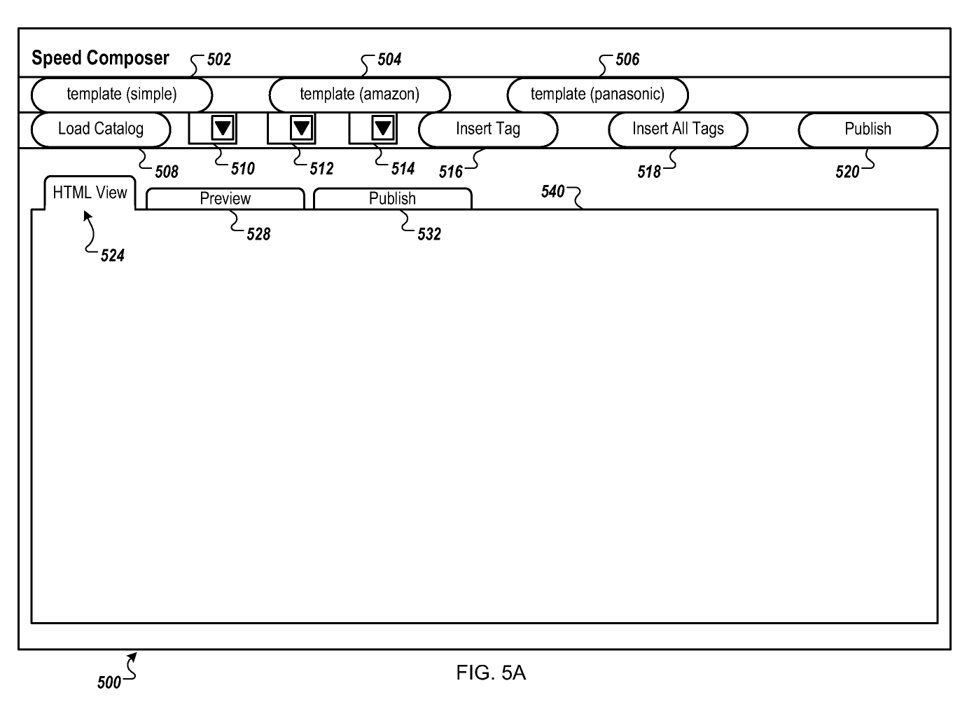

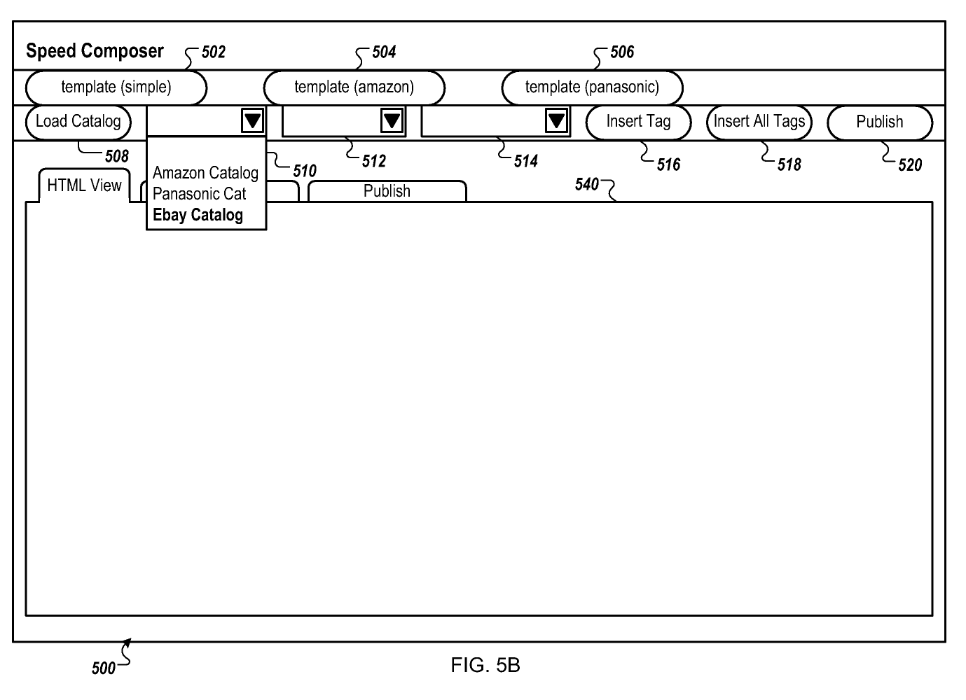

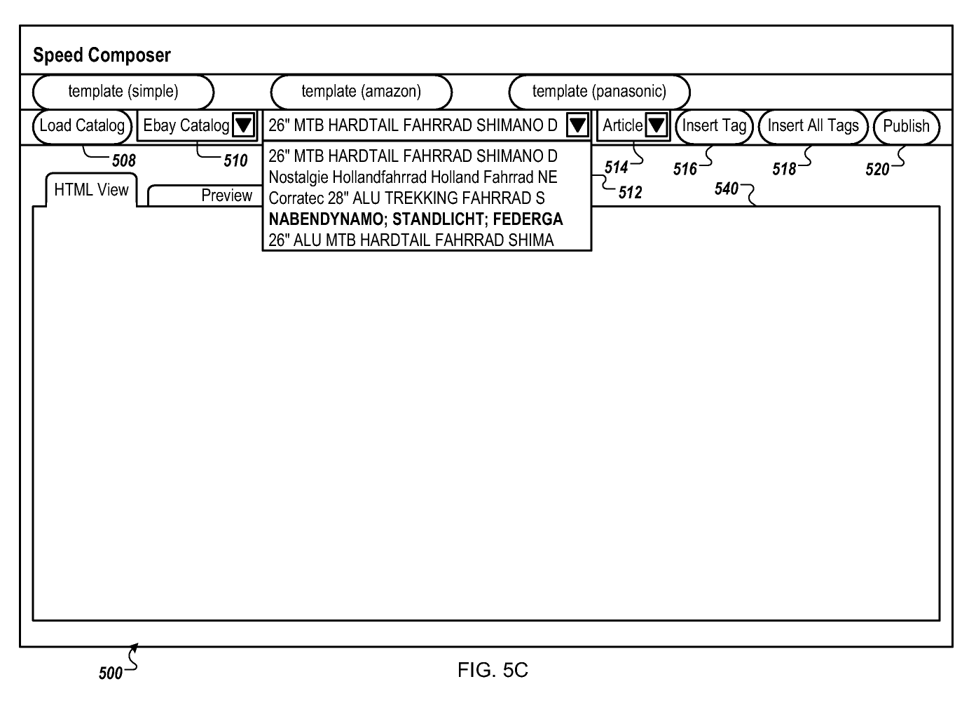

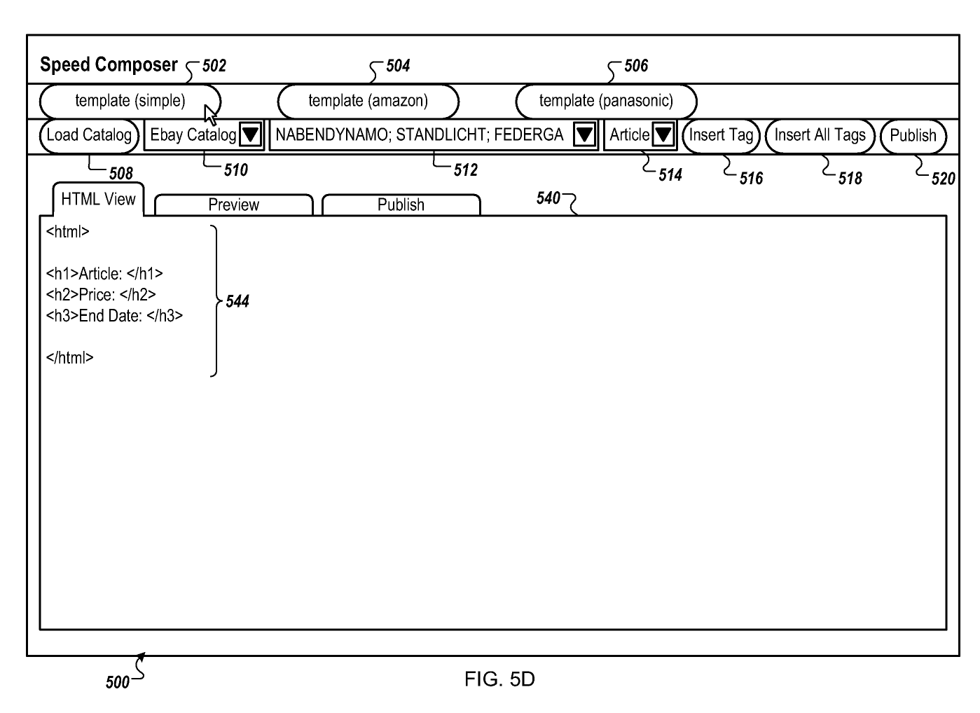

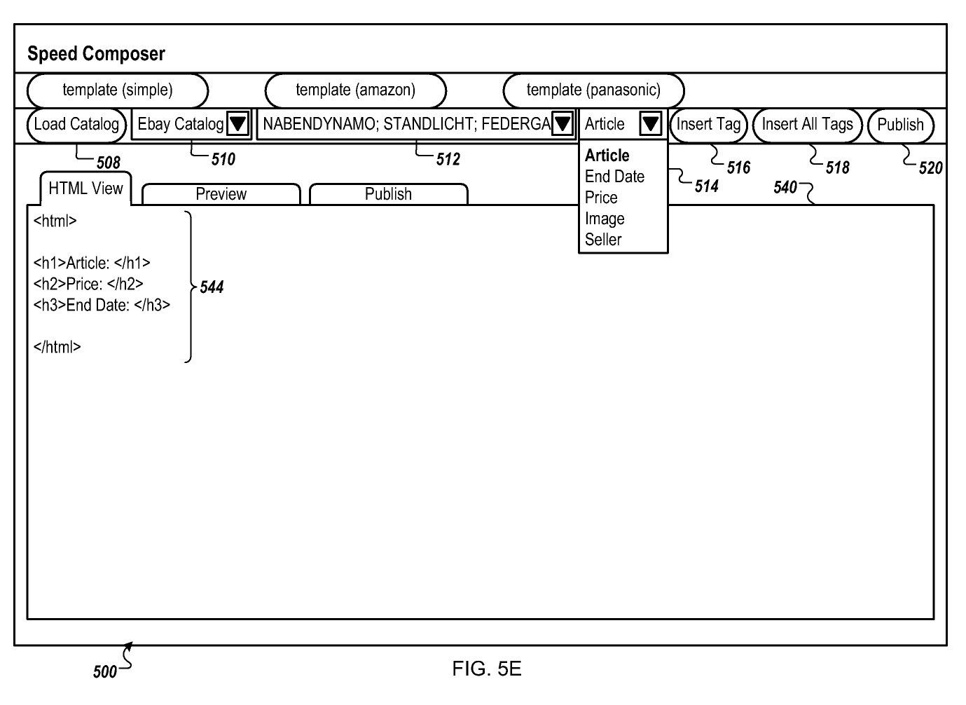

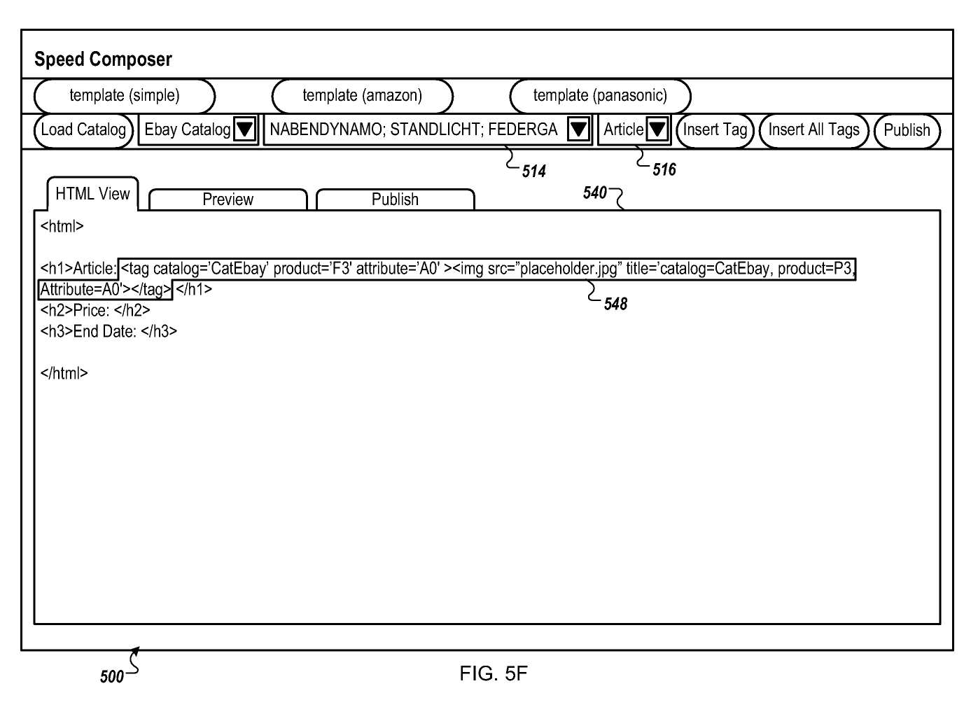

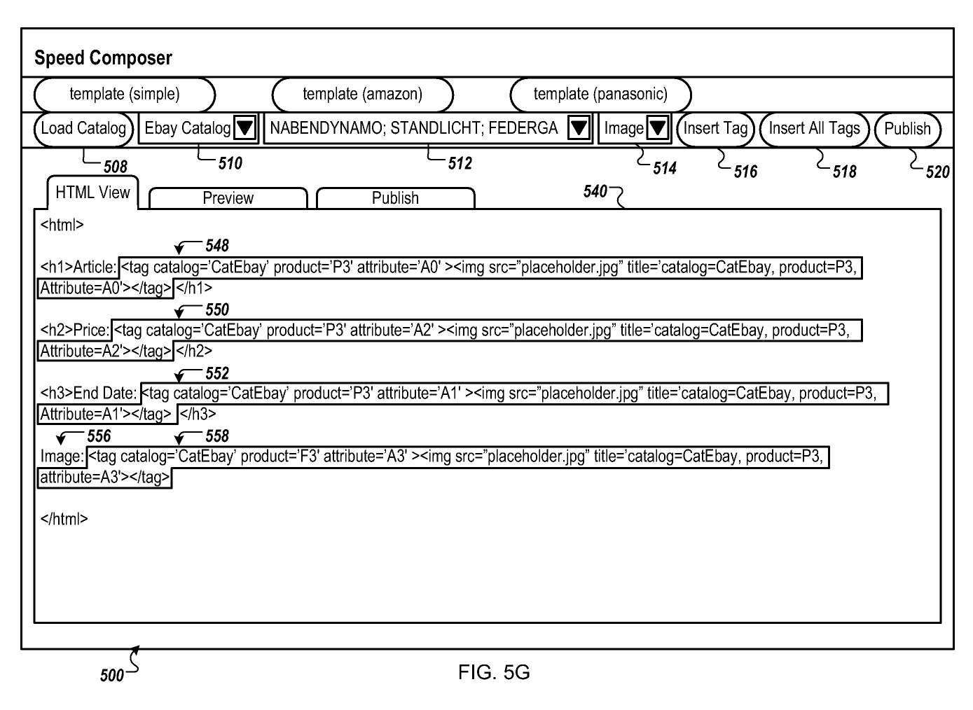

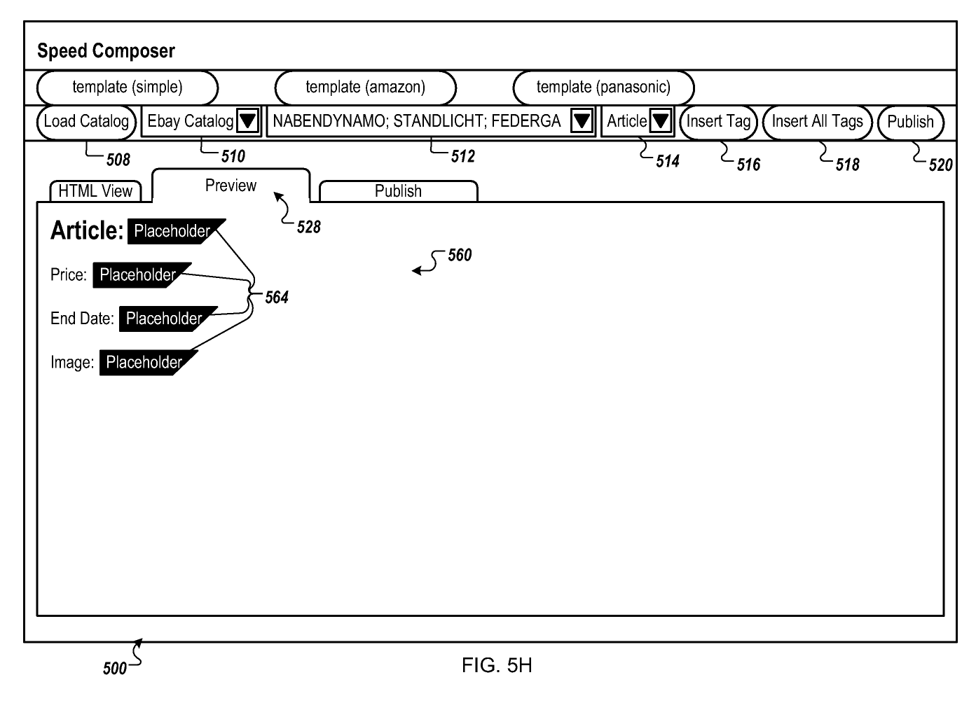

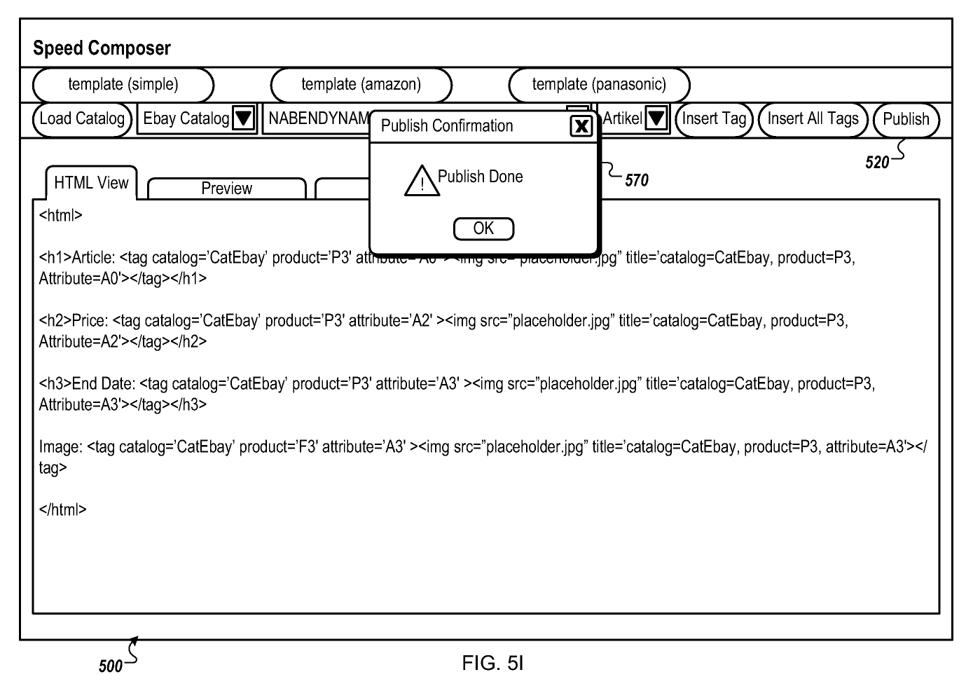

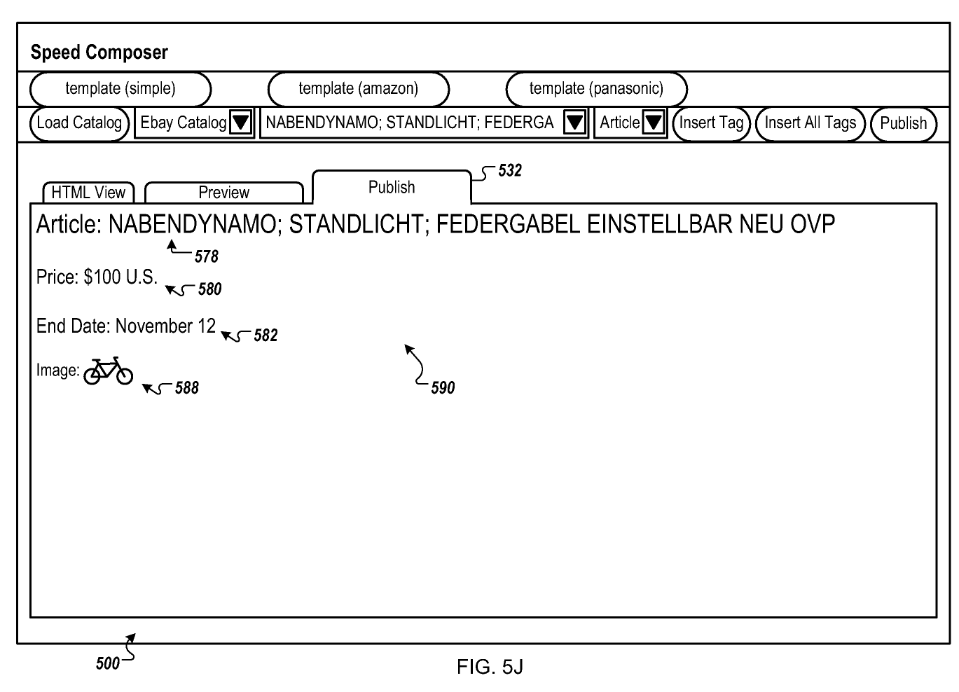

The GUI 122 of the web developer 120 comprises a graphical user interface operable to allow its user to interface with at least a portion of environment 100, allowing the user to design web pages 150, web page templates 148, and generally interact with the WCMS 136. The GUI 122 offers users functionality similar to that provided by GUI 110 of the client 108, namely, an efficient and user-friendly presentation of data provided by or communicated within the system. Therefore, the GUI 122 can be any graphical user interface that processes information and efficiently presents the results to the user. The UI elements of the GUI 122 can be related to the functions of one or more applications executing at the web developer 120, such as a business application or web browser. In some instances, the web developer 120 may interact with and design web pages 150 or web page templates 148 using browser-based interfaces associated with the WCMS 136. In other instances, each web developer 120 may include a client design application (not shown) that can be used to develop and design web pages apart from the web development server 112, and that can be later uploaded to the WCMS 136. Further, the web developer 120 may also be a client 108 as described with regards to FIGS. 1A and 1B, while a client 108 may also be a web developer 120. FIGS. 5A-5J illustrate one embodiment of the visual interface of the WCMS 136 provided to the GUI 122 allowing for the design of web pages according to the implementation of FIGS. 1A and 1B. FIGS. 5A-5J will be described in detail along with the description of FIG. 3.

Returning to FIG. 1B, the WCMS 136 comprises a plurality of modules, including, but not limited to, a publish module 154, an event listener module 156, a version control system 158, and a database application programming interface (API) 160. The publish module 154 allows web developers 120 and/or the WCMS 136 to publish a design-time web page 150 or republish an archived web page 152 to the production web server 104 by replacing the one or more metadata data structures in the web page with the information or content retrieved from the content repository 140 via one or more design-time queries based on and defined by the information included in the metadata data structures themselves. Once the metadata data structures have been replaced with the dynamic information, the publish module 154 stores the updated (or populated) web page 132 at the production web server 104. The WCMS 136 uses the functionality of the database API 160 to generate the appropriate queries and otherwise communicate with and retrieve data from the appropriate content repositories 140 via the network 128. For instance, the database API 160 may analyze each metadata data structure included in the web page being published, and execute a query directed to the data of the identified back-end server 116 and/or content repository 140 defined by the data structure. Once the query is generated, the WCMS 136 uses the database API 160 to send the query to the appropriate back-end server 116 (arrow 174 of FIG. 1A). The results of the query are returned from the back-end server 116 (arrow 176), and the results may be analyzed or translated by the database API 160 into the correct format for insertion into the web page prior to being passed to the publish module 154. The received results represent the dynamic information as it existed at the time of the query, and can be inserted directly into the text or content of the web page to be published in place of the corresponding metadata data structure. In some instances, the publish module 154 may save a copy of the web page updated with the dynamic information with a set of published web pages 153 at the web development server 112. Further, once each metadata data structure in the web page to be published has been replaced with data retrieved from the appropriate content repository, a copy of the updated web page is sent to the production web server 104 to be stored as a published web page 132.

The back-end server 116 represents a server including at least one content repository 140 in its memory 118, each content repository 140 storing data associated with the one or more web pages designed, generated, and published by the WCMS 136. Content repositories 140 may be a database, a spreadsheet, a tab-delimited text file, a comma-delimited text file, a flat file, or any other file format that contains structured information capable of being defined by a metadata data structure. The content repositories 140 may contain any information relevant to the web pages associated with the software environment 100. In one instance, one or more of the content repositories 140 may include information on products sold by an online retailer, including product names, product pricing, product descriptions and/or specifications, product images, product sources (e.g., manufacturers), product inventory, and seller information, among others. In general, the content repositories 140 represent databases containing sets of dynamic information relevant to the design-time web pages 150 being designed using the WCMS 136. It will be understood that a set of dynamic information can comprise any appropriate results of a query to the content repository including one or more discrete data items. In some instances, one or more of the content repositories 140 may be created specifically for a particular web page designed by the WCMS 136. In other instances, one or more of the content repositories 140 may have existed prior to the design and/or creation of the associated web page 150. Further, the information contained in the content repository 140 may be defined by a plurality of sources, including manufacturer catalogs, manual entry, and automated retailer data, among others. In one instance, a client 108 or web developer 120 can manually add, delete, or modify information to or from a content repository 140 by accessing the repository 140 through the network 128. In other instances, the content repository 140 can be populated and/or modified by one or more business applications 124 or other external data sources 144 (see arrow 184 of FIG. 1A).

At a high level, business application 124 may be any application, program, module, process, or other software that, during its execution, can access, modify, delete, add, or otherwise manage information within a content repository 140. In some instances, a business application 124 may execute or provide a number of application services, including customer relationship management (CRM) systems, human resources management (HRM) systems, financial management (FM) systems, project management (PM) systems, knowledge management (KM) systems, and electronic file and mail systems. The business application 124 may be operable to exchange data with a plurality of enterprise-based systems and, in the process, update or modify one or more content repositories 140. The various services performed may allow the business application 124 to orchestrate one or more business processes in synchronization with other processes that directly or indirectly affect the information stored within one or more of the content repositories 140. For instance, a business application 124 may drive business processes across different applications, systems, technologies, and organizations, thus driving end-to-end business processes across heterogeneous systems or sub-systems. The business processes associated with a particular business application 124 may cause updates, modifications, additions, or deletions to one or more content repositories 140. In some instances, a business application 124 may be specifically designed or programmed to manage or interact with a particular content repository 140, such as an inventory or pricing system used by a retailer. These applications 124 may periodically update the associated content repositories 140 so that the information stored in a particular repository 140 will be updated regularly.

In some instances, the information stored in the one or more content repositories 140 may also be modified or updated by other external data sources 144 or events, such as an archiving service that updates information from one or more sources according to a predefined schedule that updates the content repository 140. Alternatively, an auto-update function associated with one or more of the content repositories 140 may automatically change or update information for a repository 140 based on any number of events or factors external to the software environment 100. For instance, one of the content repositories 140 may contain information related to products sold by a retailer, including the products' price and availability. Information stored in that particular content repository 140 may be imported or retrieved from a third-party data source, such as a manufacturer's product database, on a regular or periodic basis. For instance, a manufacturer may update the suggested retail price of a particular product at certain times. The manufacturer may automatically send out those updates when they are made, or the content repository 140 (or back-end server 116) may know to check for updates at certain times, such that the pricing information for the product will be updated even if no information is received notifying the content repository 140 of the change. In another instance, if one of the content repositories 140 provides information about a retailer's stock, and one or more of the items in stock are sold (e.g., either online or at a brick-and-mortar location), then the one or more content repositories 140 may be updated to reflect such a sale. Other suitable sources, both internal and external to the software environment 100 of FIGS. 1A and 1B, can be used to update one or more of the content repositories 140 as appropriate, including manual user modifications.

Dynamic information is generally considered information that is subject to change. For example, this information can include data that changes in response to external events such as inventory, pricing, product description, currency conversion, and such. As such, the dynamic information stored in the one or more content repositories 140 can be modified during the life of a published web page 132. In some instances, the information stored at the one or more content repositories 140 may be periodically updated, while in other instances the information may be updated in response to certain irregular or difficult to predict events. When dynamic information in the one or more content repositories 140 that has been defined or referenced by a metadata data structure and included within a previously-published web page is modified, then the published version of that web page 132 would contain obsolete, erroneous, or out-of-date information if left unchanged. In those instances, the archived web page 152 or the design-time web page 150 used to create the published web page 132 are republished by the WCMS 136 to ensure that an accurate and up-to-date web page 132—at least with respect to that particular information—is available at the production web server 104. The republishing process is similar to the publishing process, and can be performed by the publish module 154 automatically or upon request. For example, republishing may be a manual process, such as when a web developer 120 knows that the dynamic information has changed and manually initiates the republish process via the WCMS 136. In other instances, the republish process is automated to ensure that the published web page 132 represents a correct set of data at most, if not at all, times.

When the republish process is automated, the WCMS 136 can be responsible for identifying when republishing is necessary or proper. To identify whether to republish a previously-published page, the WCMS 136 determines whether any changes or modifications have been made to the relevant portions of the one or more content repositories associated with a published web page (see arrow 186 of FIG. 1A). It will be understood that while described in terms of WCMS 136, any component or module that is capable of identifying that a change occurred or responding to such an identification may be used. Two example methods of automatically identifying whether to republish are described, although other suitable methods can be used.

In a first example, the publish module 154 (or another portion of the WCMS 136) may be set or programmed to poll the one or more content repositories 140 associated with the metadata data structures inserted into a particular web page in progress 150 or archived web page 152 at predetermined intervals. The predetermined intervals can be any appropriate time period, and may be set to a default value (e.g., once every day) or modified by an authorized user to custom times (e.g., at 10:00 AM, 2:00 PM, and 4:00 PM every day). These predetermined intervals may also be of an undetermined length, and instead controlled by externals, but often known, events (such as data refreshes, data loads, period closings, database reorganizations, reconciliations, and so forth). Polling can include querying each of the one or more relevant content repositories 140 to determine whether the information defined or referred by the one or more metadata data structures changed since the initial publishing process occurred. If no changes were made to the one or more content repositories 140 since the previous publishing, then the web page is current and does not need to be republished. However, if data defined by any of the metadata data structures within the design-time web page 150 or archived web page 152 has changed, then the web page is republished by having the publish module 154 query the relevant content repository for the updated information (see arrow 186 of FIG. 1A), receive the updated dynamic information from the back-end server 116 (see arrow 188 of FIG. 1 A), replace the metadata data structures in the relevant pages with the updated dynamic information, and send the updated web page 132 to the production web server 104 (see arrow 190 of FIG. 1A). The publish module 154 may require that the web page (or development server) register such dynamic tags or the publish module 154 may automatically parse a web page (perhaps during publishing) to maintain a relatively up-to-date list of such metadata data structures.

In the second instance, the method for identifying whether the relevant information in the one or more content repositories has been modified is implemented using two additional example components, one located at the back-end server 116 and the other at the web development server 112. Of course, these components may merely represent an additional thread, process, applet, or other sub-module of an existing module. At the back-end server 116, an event trigger module 162 can store information associated with each web page published using dynamic information from the one or more content repositories 140. For instance, if a certain web page retrieves price information regarding product X when it is published, the event trigger module 162 can create a trigger on the content repository 140 such that when there is any change to the price information for product X, the event trigger module 162 will be activated. In addition to storing information regarding the relevant data to watch in the one or more content repositories 140, the event trigger module 162 also stores information identifying for which design-time web pages 150 or archived web page 152 the WCMS 136 retrieves the information. Thus, when the event trigger module 162 is activated or triggered by a change to information stored in one of the content repositories 140, the event trigger module 162 can send a notification message through the network 128 to the event listener module 156 of the WCMS 136 including the particular web page or pages to be republished. The event listener module 156 of the WCMS 136 receives the notification message, and notifies the publish module 154 of the design-time web pages 150 and archived web pages 152 affected by the content repository 140 modification, and which need to be updated. Once the proper design-time web pages 150 or archived web pages 152 are identified, the publish module 154 queries the appropriate content repository 140 for the updated dynamic information (arrow 186), receives the updated dynamic information from the back-end server 116 (arrow 188), replaces the metadata data structures in the design-time web page with the updated dynamic information, and sends the updated web page 132 to the production web server 104 (arrow 190).

In combination with the republishing functionality, the WCMS 136 may also include a version control system 158. The version control system 158 allows the WCMS 136 to manage multiple revisions to the same web page. Each time a web page is redesigned, the version control system 158 retains a copy of the older, previous version by storing a copy of the unpublished web page (i.e., the version including the metadata data structures) in the set of archived web pages 152. Additionally, previous versions of the published web pages (i.e., where the metadata data structures have been replaced with the dynamic information from the content repository 140) can be stored in the set of published web pages 153. Thus, the version control system 158 can allow developers to archive multiple versions of the various web pages to control and track changes made to both the static and dynamic portions of the web pages. This allows a newer version of the page to be concurrently developed with an older version capable of being dynamically republished with more up-to-date dynamic information.

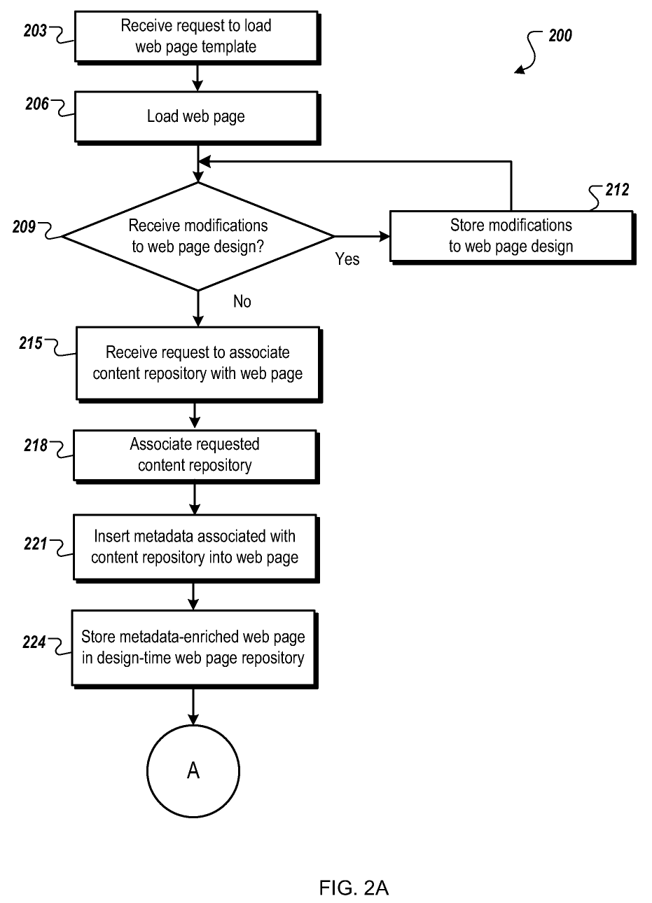

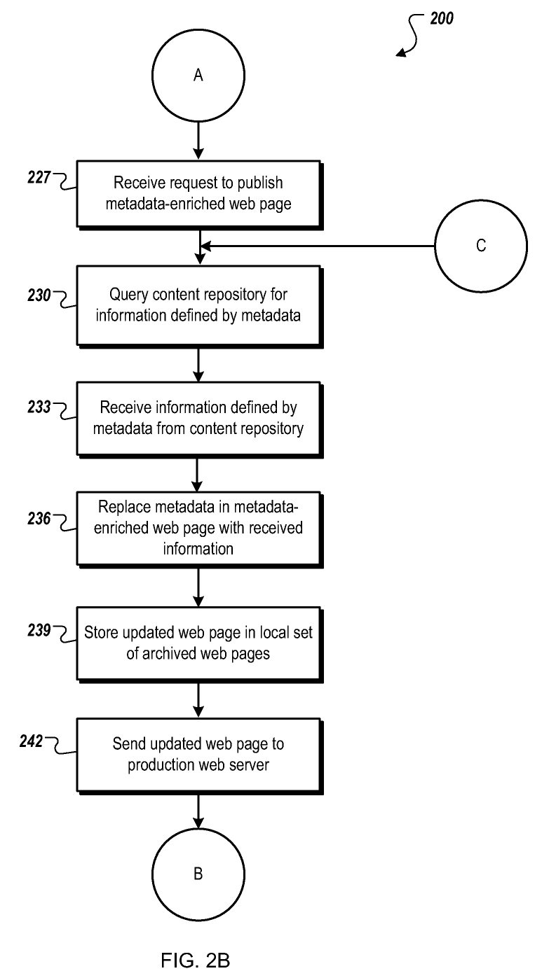

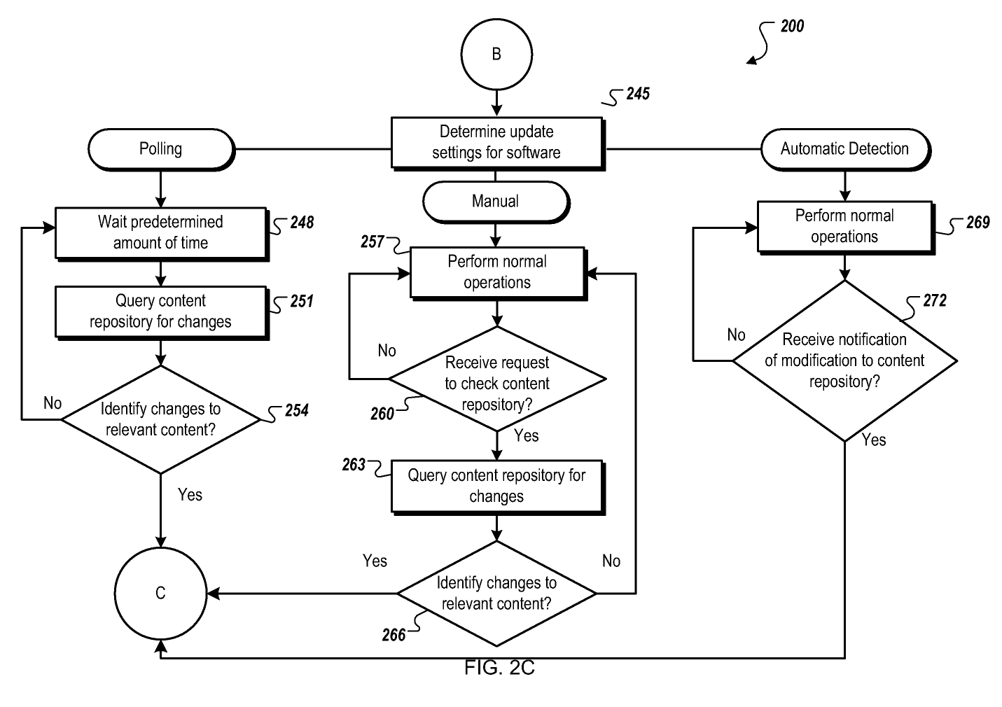

FIGS. 2A-2C are flowcharts illustrating one particular implementation of a method 200 for integrating dynamic information into a web page prior to placing the web page into production as seen from the perspective of the WCMS. In particular, FIG. 2A illustrates the initial creation and definition of a web page to be used for integrating dynamic content, FIG. 2B illustrates the process of publishing a metadata-enriched web page to a production web server from the WCMS, and FIG. 2C illustrates the republish process according to one of three possible methods. Method 200 may be performed, for example, by any suitable software environment. However, for clarity of presentation, the description that follows uses the software environment 100 as the basis for an example for the describing the method. It will be understood that any other suitable system or environment, or combination of systems or environments, may also be used to perform method 200.

At 203, a WCMS (e.g., WCMS 136 of FIGS. 1A and 1B) receives a request to load a particular web page template stored at the web development server 112. In some implementations, the request may be sent by a web developer in the process of designing one or more web pages using the WCMS. At step 206, the WCMS loads the requested web page template from memory. For example, by loading the web page template, the WCMS may present the requested template at a GUI associated with the requesting web developer (e.g., GUI 122). In some instances, however, the WCMS may not receive a request to load a web page template at 203. In those instances, the WCMS may receive a request to load a previously-designed web page, or instead, may not receive a request to load any web page at all. Where no web page or template is requested, a blank document may be presented to the GUI of the web developer, allowing for an entirely new web page to be created.

At 209, the WCMS determines whether any modifications to the loaded web page template (or web page) have been made. If changes have been made, such as a modification to the layout or presentation of the web page, the WCMS stores the modifications in memory at 212. In some instances, the determination of 209 as to whether modifications have been made may not necessitate that those changes be immediately stored, at least until a request according to 215 is received. In some instances, and prior to 215, modifications to a web page or web page template may be saved based only by a manual request from the web developer or according to a set of auto-save rules defined for the WCMS. Where a web page template was initially requested at 203, the modifications to the web page template may be stored to overwrite the previous template, as a new web page template, or as a new web page based on the original template. If no additional changes have been made to the web page or the web page template, then method 200 can continue at 215.

At 215, the WCMS receives a request to associate a particular content repository with the loaded or current web page. In some instances, the WCMS can be associated with any content repository communicably coupled to the network. In other instances, the WCMS may be aware of one or more content repositories included within a local environment based on previous associations with or predefined links to those repositories. In some instances, the WCMS can actively search a certain environment (e.g., the software environment 100) to locate one or more potential content repositories for association. Further, the WCMS may have a defined link to a particular back-end server, such that any content repository stored on that particular back-end server are available for association with web pages designed in the WCMS.

At 218, the WCMS associates the requested content repository with the web page. Associating a content repository with a web page can mean that certain metadata data structures, such as metatags, that define the dynamic information within the associated content repository, are made available for insertion into a web page by the WCMS. In some instances, associating the content repository may include a preliminary query of the associated repository to retrieve the repositories available fields. For example, associating a content repository with a catalog of books may include retrieving the names of the fields included in the content repository (e.g., book title, author, suggested retail price, ISBN number, and book cover image), and possibly retrieving values associated with a unique value (or primary key) defined in the catalog (e.g., the book title). For instance, if a content repository comprised a catalog of available books from Amazon.com, the fields described above could be retrieved from the repository, and the values for the book title field could be retrieved as the unique value associated with the content repository to assist in defining the metadata data structures for insertion into the web page. This association allows web developers to identify the information defined by the metadata data structures and to accurately design the web pages.

At 221, the WCMS inserts the appropriate metadata data structures identified by a web developer into the web page. In some instances, the specific locations for individual metadata data structures may be identified by the web developer before a request to insert the data structure is be received. When a request to insert the metadata data structures is received, the appropriate metadata data structure will be inserted into the identified location. In instances where a web template is initially loaded at 203, the original template text may include text placeholders for the metadata data structures associated with the various fields. In those cases, once the unique value defining the content repository fields is selected, all of the related fields with predefined placeholders may be inserted at once. By predefining the location for the fields, similar web pages can be generated rapidly with little to no user interaction. For some well-defined templates, inserting the appropriate metadata data structures may be automated to create a plurality of web pages from a single web template by publishing a web page for each item stored in a particular content repository. Once one or more metadata data structures have been added to a web page, that web page may be considered a metadata-enriched web page.

At 224, when the insertion of the metadata data structures into the web page is complete, the WCMS stores the metadata-enriched web page in a design-time web page repository. For instance, in FIG. 1B, metadata-enriched web pages can be stored in the set of design-time web pages 150 prior to publishing. At this point, the metadata-enriched web pages contain static information, including the metadata data structures that have been inserted into the web page. A preview of the web page as designed would not include the information defined by the metadata data structures, but instead would include the metadata data structures themselves. In some instances, a placeholder image associated with each metadata data structure may be included to indicate that a metadata data structure is located at a particular location.

Continuing at FIG. 2B, a request to publish the metadata-enriched web page is received by the WCMS at 227. In some instances, the request may be received directly from a web developer or user associated with the WCMS. These manual requests may be received immediately after 224 of FIG. 2A. In some other instances, however a stored metadata-enriched web page may not be associated with a request for publishing for some time after 224 of FIG. 2A, and in some instances, will never be published. In still other instances, the WCMS may control the timing of web page publishing based on certain rules or events associated with the production web server, the web development server, or other defined events or times. In those instances, the request to publish the metadata-enriched web page is received after the occurrence or triggering of some predefined event, such as a daily or hourly publishing setting, or the time associated with a standard update to one or more of the content repositories associated with the web page.

After receiving the request to publish, the WCMS begins the publish process at 230, where the WCMS queries the associated content repository for the information defined by the metadata data structures previously inserted into the web page at 221. In some instances, such as those described with regards to FIG. 1B, the WCMS may include a database API 160 capable of interacting with the associated content repositories, including generating the queries to request and retrieve the information defined by the metadata data structures of the metadata-enriched web page. Once the query is generated, the WCMS sends the query to the content repository.

At 233, the WCMS receives the dynamic information defined by the metadata data structures as requested by the query of 230. In some instances, the database API 160 analyzes and parses the information received from the content repositories, and provides that information to a publish module 154 as illustrated in FIG 1B after the information has been appropriately processed. At 236, the WCMS replaces the metadata data structures inserted into the metadata-enriched web page with the appropriate dynamic information received from the queries of the content repositories. Once the dynamic information replaces the metadata data structures, the web page may be considered an updated web page.

At 239, the updated web page can be stored in a set of archived web pages located locally at a web development server hosting the WCMS. In some instances, the set of archived web pages may be stored remotely from the WCMS, such as in an archive database or version control system. By storing the updated web page in the set of archived web pages, errors made by future publish or republish processes can be corrected by reverting to the last valid updated web page stored in the set of archived web pages. Once stored locally, the WCMS sends the updated web page to the production web server at 242, where the updated web page can be made accessible to a plurality of clients via the network, such as through the Internet. The updated web page may now be considered a published web page and is available to all computers communicably coupled to the production web server.

Continuing at FIG. 2C, the WCMS determines its web page update settings at 245. As previously described, the dynamic information defined by the various metadata data structures is likely to change at least once during the lifetime of a published web page. Once the dynamic information changes in the content repository, the published web page will no longer reflect the correct current status of the dynamic information. Returning to the Amazon.com example discussed above, if a web page describing a book is published, and the price of the book is later changed in the associated content repository, then the new price of the book will not be available to the published web page. In order to provide an accurate description of the book, the metadata-enriched web page must be republished so that the new price (and any other modified information) will be included in the published web page. FIG. 2C illustrates three methods of republishing or updating the web page. Based on the update settings is defined for the WCMS, the type of update is determined. In some instances, different web pages may be associated with different update settings as appropriate.

The first update setting illustrated in FIG. 2C is the polling method. The polling method is ideal for web pages that are associated with content repositories that are modified at consistent or defined intervals. For example, when a web page is associated with a content repository that is updated at certain defined times each day, the polling method may provide the most efficient update for the web page. As shown at 248, the web content management software waits a predetermined amount of time after publishing or republishing a web page. In some instances, the predetermined amount of time may be constant intervals, while in other instances, the waits may be set at different lengths of times (e.g., every three hours during the working day from 8:00 AM until 6:00 PM, and then not again until 8:00 AM the next morning). This may allows the WCMS and its associated computer system to avoid unnecessary or excessive updates when the information associated with the content repository will not be modified during specific times.

After the predetermined amount of time has elapsed, at 251 the WCMS queries the content repository associated with the particular web page to determine whether any changes have been made to the dynamic information defined by the metadata data structures inserted into the design-time version of the web page. At 254, the WCMS determines whether any changes to the relevant content is identified by the query of 251. If no changes are identified, method 200 returns to 248, where the WCMS again waits a predetermined amount of time before checking again for changes. If, however, changes are identified, then the metadata-enriched web page is to be republished, and method 200 returns to 230 of FIG. 2B, where the content repository is queried for the updated dynamic information defined by the metadata data structure of the metadata-enriched web page. In some instances, the polling method may skip steps 251 and 254, returning directly to step 230 after waiting the predetermined amount of time. In those instances, the web page will simply be republished after each predetermined interval of time without determining whether the update was necessary or not. This option is best-suited for web pages associated with constantly updated content repositories, where the query of 251 and the determination of 254 will almost always result in a determination that republishing is necessary. In still other instances, the polling query of 251 may be used in lieu of 230 and 233, such that after changes to the content repository are identified at 254, the method returns to 236 to replace the metadata data structures using the results received from the query of 251.

The second update setting illustrated in FIG. 2C is the manual update. After publishing the web page at 242, the WCMS performs its normal operations at 257. At 260, the WCMS determines whether it has received a request to check for updates to the content repository associated with the metadata-enriched web page. If no such request has been received, the WCMS returns to 257 to perform its normal operations. If, however, a manual request to check for updates is received, then method 200 continues at 263 where the WCMS queries the content repository associated with the particular web page to determine whether any relevant changes have been made to the content defined by the metadata data structures inserted into the web page. At 266, the WCMS determines whether any changes to the relevant content is identified. If no changes are identified, method 200 returns to 257, where the WCMS continues to perform its normal operations. If, however, changes to the relevant dynamic content is identified, then the metadata-enriched web page is to be republished, and method 200 returns to 230 of FIG. 2B, where the content repository is queried by the WCMS for the dynamic information defined by the inserted metadata data structure. The manual method of updating published web pages is best suited for instances where the content repository is primarily updated only by a user interacting directly with both the content repository and the WCMS. In those instances, the user knows when the content repository has been updated, and is able to immediately request republishing of the metadata-enriched web page so that the current information is reflected in the published web page. Where changes to the content repository are automated and/or frequent, the manual republish method may not be the best method for updating and republishing the web page.

The third method for updating the web page is the automatic detection method of FIG. 2C. This method can greatly simplify the update process, requiring updates only when changes are made to the relevant content repositories and without requiring the WCMS to determine whether or not an update is necessary. In this method, the content management system performs its normal operations at 269. At 272, the WCMS determines whether a message notifying the system of a relevant modification or update to the content repository has been received. If no such message has been received, method 200 returns to 269 and the WCMS returns to its normal operations. However, if the WCMS determines that such a notification has been received, the method continues at step 230 where the republish process is performed on the metadata-enriched web page to integrate the updated dynamic information. As illustrated in FIG. 1B, the automatic detection update method may be performed using an event listening module 156 that receives messages from an event trigger module 162 associated with a particular content repository 140. The event trigger module 162 monitors the fields of the content repository 140 relevant to the web page to determine whether any of those fields have been changed since the last publishing of the web page. If the event trigger identifies a relevant modification, the notification message is sent to the event listener module 156 of the WCMS 136. Once the message is received, the WCMS 136 can initiate the republish process immediately, without determining whether or not the relevant portions of the content repository 140 have been updated. This method is ideal for web pages associated with content repositories that are frequently changed, but at unpredictable intervals. Additionally, the primary portion of the processing is performed by the back-end server 116 and the event trigger module 162, with the WCMS 136 simply responding to the notification messages received during its normal operations. While only these three methods are described, any number of possible republish methods are possible and can be understood from this disclosure

FIG. 3 is a flowchart illustrating one example of a method 300 for generating a web page integrated with dynamic information from a content repository using the WCMS interface from the perspective of a web developer (or a user associated with the web developer). The method 300 will be described with references to FIGS. 5A-5J illustrating the various interactions with the an example GUI presenting the WCMS interface 500. Examples of method 300 may be described in terms of the software environment 100. However, it should be understood that any other suitable system or environment may also be used to perform the method 300. Further, alternative WCMS interfaces 500 may also be used in other implementations of method 300.

At 302, the web developer loads a WCMS interface. As described in connection with FIGS. 1A and 1B, the WCMS interface may be a browser-based interface available via a network connection to the web development server 112, or alternatively, the WCMS interface may be available through a WCMS client application executed at the web developer and communicably connected to the web development server 112. Any other suitable type of WCMS interface can also be used.

FIG. 5A illustrates an example of the WCMS interface 500. The interface 500 includes a number of UI elements, including buttons associated with one of three templates (simple 502, Amazon 504, and Panasonic 506), a Load Catalog button 508, an Insert Tag button 516, and Insert All Tags button 518, and a Publish button 520. The display area 540 also includes three tabs for several views available via the interface 500: the HTML view tab 524, the Preview view tab 528, and the Publish view tab 532. Each of these elements will be described in more detail below.

Returning to FIG. 3, the web developer can select a particular content repository to be associated with a web page at 304. To do so, the web developer may first activate the Load Catalog button 508 in the WCMS interface 500 (shown in FIG. 5A). In some instances, the WCMS may be pre-associated with one or more content repositories, such as those located within the software environment 100 illustrated in FIGS. 1A and 1B. In other instances, activating the Load Catalog button 508 may cause a pop-up or dialog box to appear, allowing the web developer to define a location (internal or external to the software environment 100) for additional content repositories to be located or identified by the WCMS. As shown in FIG. 5B, three content repositories (Amazon Catalog, Panasonic Catalog, and Ebay Catalog) are currently recognized by the WCMS in the present implementation after activating the Load Catalog button 508, and each are included in the content repository dropdown box 510 adjacent to the Load Catalog button 508.

Returning again to FIG. 3, the web developer loads the selected content repository at 308. By activating (i.e., clicking on) one of the three content repositories provided in the dropdown box 510, the web developer causes the web content management system to load the selected content repository. Once the selected content repository is loaded, a list of items included in the content repository can be displayed in content repository item dropdown box 512, located to the right of the content repository dropdown box 510 in FIG. 5C. In addition to the list of items provided by dropdown box 512, an item field dropdown box 514 is populated with fields associated with or defining the items included in the content repository item dropdown box 512.

At 312, the web developer can determine whether changes to the selected content repository (e.g., the Ebay catalog content repository loaded in FIG. 5C) are to be made. If the web developer determines that changes are to be made, then at 316, the web developer or another user associated with the selected content repository can update the information included within the repository. Once the information is modified, method 300 returns to 308, where the selected content repository is reloaded with the most up-to-date information. In some instances (similar to those described in FIG. 2C), the WCMS may automatically determine that changes to the content repository have been made, and may automatically reload the selected content repository. In other instances, the web developer may need to re-activate the Load Catalog button 508 or reselect the content repository for the changes to be reflected in the WCMS interface 500. If at 312 no additional changes to the content repository are made, method 300 continues at 320.

At 320, the web developer can select a web page template (i.e., one of the templates already provided in WCMS interface 500) to begin work in, or may instead create a new web page or web page template by drafting the desired HTML code (or another appropriate web-based language such as XML). For instance, in the HTML view of the interface 500, the web developer can simply add HTML or XML tags and content into the display area 540. As shown in FIG. 5A, the web developer can select one of the predefined web page templates (502, 504, or 506) to use as a basis for the web page design. For instance, in FIG. 5D, the simple template has been selected (i.e., by activating the Simple Template button 502), and the Simple Template 544 has been provided in the display area 540.

Returning to FIG. 3, at 324 the web developer can determine whether modifications to the static content of the web page is necessary or desired. For instance, a web page template loaded into the WCMS interface 500 may be close to the desired design, but one or more changes may be desired before the user is satisfied with the final result. If no changes are to be made, method 300 continues at 336. However, if changes are desired, the web developer can use the inherent functionality of the WCMS to modify the coding for the presentation and layout of the web page at 328. In many instances, the modifications or customizations to the web page can be made directly in the WCMS interface 500 via the HTML view. The interface 500 may provide additional web development tools (not shown) that can offer advanced functionality for web page development. Once changes are complete, the customized web page can be stored or saved by the web developer at 332. The WCMS interface 500 may include save or versioning functionality that allow the original versions of and the updates to the web page or template to be saved.

At 336, the web developer selects the metadata data structures to be inserted into the web page. For instance, one of the items from the content repository item dropdown box 512 (FIG. 5C) can be selected. Once the desired item is chosen, it will appear as selected in the interface (see 512 in FIG. 5D-5J). Additionally, the fields associated with each item will be provided in the item field dropdown box 514. The five fields illustrated in this particular implementation include an article, an end date, a price, an image, and a seller as shown in expanded dropdown box 514 (as shown in FIG. 5E). The web developer can choose one of the item elements by activating (i.e., clicking on) the chosen item field from the dropdown box 514. The selected item field will be shown in the item field dropdown box 514 as illustrated in FIG. 5F (where the article field has been chosen).

At 340, the web developer identifies the appropriate location in the web page to insert the metadata data structure selected at 336. In some instances, this may be performed by the web developer moving the cursor to the location within the web page shown in the HTML view. In some instances, the selected web page template or web page may also include one or more placeholders for the metadata data structures (e.g., specific text providing the WCMS with a defined location for particular types of dynamic information). In those instances, the WCMS may be able to automatically determine the correct location for insertion without requiring additional user input.

At 344, the web developer inserts the selected metadata into the identified location within the web page template or web page. As shown in FIG. 5F, the insertion can be performed by the web developer activating the Insert Tag button 516. Upon activation of the button 516, the metadata data structure for the selected item and element will be inserted by the WCMS into the location specified by the web developer. For instance, metadata data structure 548 representing the article associated with the selected item have been inserted into the web page design, as shown by the metatag 548.

At 348, the web developer determines whether additional metadata data structures should be inserted into the web page. In some instances, additional dynamic information for the item already selected may be inserted. In other instances, information associated with a different item can be added by changing the selection in dropdown box 512. If the decision is made to insert additional information, method 300 returns to 336, and the developer can select the additional metadata to insert into the web page design. As shown in FIG. 5G, metadata data structures for the price 550, end date 552, and image 558 of the originally selected item have been inserted into the web page design. Additionally, the web developer has added HTML code to the template in FIG. 5G, adding the text “Image:” 556 into the design. The image metadata data structure 558 was inserted adjacent to this new content 556. Once the web developer determines that no additional dynamic information is to be inserted into the web page, method 300 continues at 352.

At 352, the web developer can optionally preview the web page in its current stage of development before the WCMS has published the page. To preview the page, the web developer can activate the Preview view tab 528 in the WCMS interface 500. Once that Preview view tab 528 is activated, the unpublished output of the web page code is presented in the preview area 560 of the web page using virtual web server (or similar) functionality. As shown in FIG. 5H, each metadata data structure is identified in the preview page by an image placeholder 564, indicating that dynamic information will be added in its place during the publishing process. If a web developer is unhappy or dissatisfied with the presentation of the web page, modifications can be made by returning to the HTML view and modifying the code or layout.

At 356, the web developer can publish the web page to the production web server. For example, as shown in FIG. 5I, the web developer has activated the Publish button 520, activating the WCMS's publish process as described along with FIGS. 2A-2C. Once the publish process is complete, a Publish Confirmation dialog box 570 may be presented to the web developer for notification purposes.

Once the web page has been published, the web developer can review the published web page at 360. To do so, the Publish view tab 532 can be activated by the web developer (as shown in FIG. 5J). A copy of the published web page can be provided in the publish area 590 of the WCMS interface 500. As shown, the published web page is provided with the dynamic information having replaced the metadata data structure placeholders previously seen in FIG. 5H. During the publish process, the WCMS performed the queries necessary to retrieve the content repository information defined by the metadata data structures, and then replaced the metadata data structures with the dynamic information received from the query. As shown in FIG. 5J, the article name 578, price 580, end date 582, and image 588 associated with the selected item have been inserted into the web page. In alternative implementations, the web developer may review the changes in a separate GUI, such as by opening the published web page in a web browser by navigating to the address of the published web page.

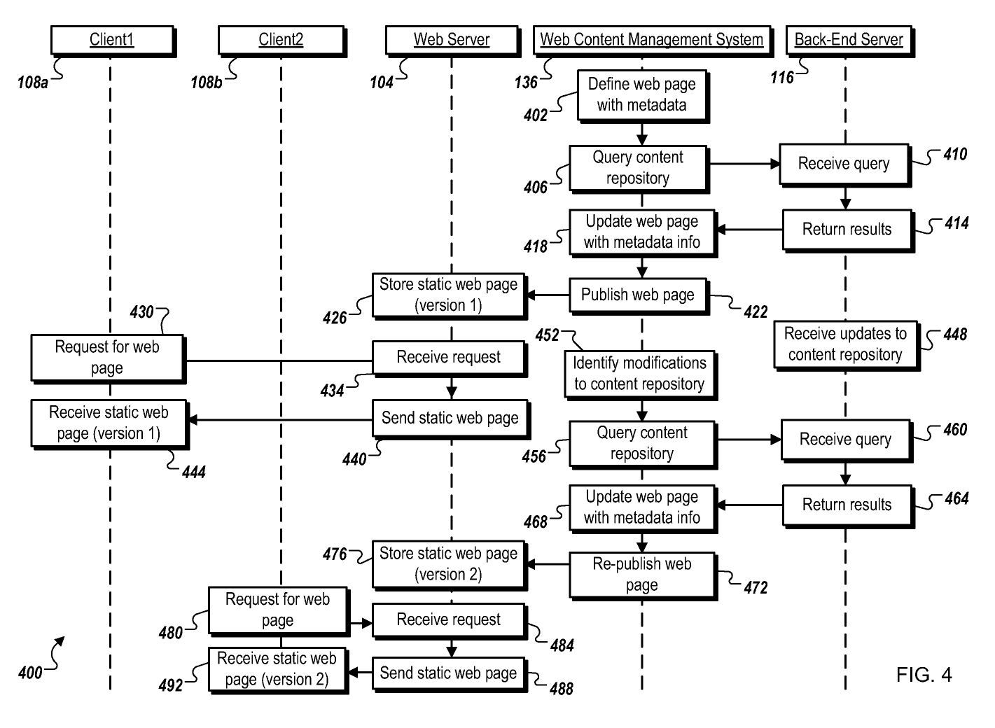

FIG. 4 is a signaling and flow diagram illustrating method 400 describing a situation wherein two clients (Client1 108a and Client2 108b) attempt to access the same web page that has been generated and updated by the WCMS 136 at two different times, once after publishing the original page, and once after updates to the associated content repository have been identified and the web page has been republished by the WCMS 136. The entities involved with the interactions of method 400 include Client1 108a, Client2 108b, the production web server 104, the WCMS 136 located at the web development server 112, and the back-end server 116. Method 400 is described in terms of software environment 100, but it should be understood that any other suitable system or environment may also be used to perform the method 400.

At box 402, the WCMS 136 receives or creates a web page that incorporates one or more metadata data structures into the web page design for seamless integration of dynamic information with the static content of the web page during design-time at the development server 112. After receiving some indication to publish the web page (whether automated or from an associated web developer 120), at box 406 the WCMS 136 queries the content repository at the back-end server 116 for the dynamic information represented by the one or more metadata data structures included in the metadata-enriched web page as previously described.

At box 410, the back-end server 116 receives the query from the WCMS 136 and retrieves the information associated with the query from one or more of its content repositories. Then, at box 414, the results from the content repository are returned by the back-end server 116 to the WCMS 136. The WCMS 136 uses those results to update the metadata-enriched web page by replacing the metadata data structures with the results of the query returned by the back-end server 116. Once the metadata data structures have been replaced, at box 422 the WCMS 136 publishes the updated web page to the production web server 104. In response, the production web server 104 stores a first version of the static web page at box 426, where the first version of the web page comprises a web page containing the original static content of the web page integrated with static representations of the dynamic information retrieved during the publish process.

At box 430, Client1 108a requests the published web page from the production web server 104 using a web browser. At boxes 434 and 440, the production web server 104 receives the request for the web page and sends (or serves) the first version of the static web page to Client1 108a as requested. Client1 108a receives the first version of the static web page via the web browser at 444, where the information associated with the first version of the web page represents the information retrieved at the time the results were returned to the WCMS 136 at boxes 414 and 418.

At some point after the first version of the web page was published, the back-end server 116 receives one or more updates to various information in one or more of its content repositories at box 448. Depending on the update setting, the WCMS 136 identifies the fact that relevant changes to the one or more content repositories have been made that affect the previously-published web page. As previously described in FIG. 2C, the WCMS 136 may be set to either poll the content repositories at certain intervals, to receive notifications from an event trigger module at the back-end server notifying the WCMS of relevant changes to a content repository, or to receive manual requests for updates from web developers or other users. In any event, once the modification or update is identified, the WCMS 116 queries the appropriate one or more content repositories at the back-end server 116 that have been updated at box 456. Additionally, in some instances the WCMS 116 may query all content repositories associated with a web page, even when changes to only one associated content repository are identified. This additional step provides a stronger likelihood of retrieving all updates to the dynamic information, but may also add additional processing time or load on the WCMS 136. The proper setting should be determined on a case-by-case basis. The back-end server 116 receives the queries at box 460, and returns the updated results of the query to the WCMS 136 at box 464. Once the WCMS 136 receives the updated information, at box 468 the metadata data structures defined for the web page at box 402 are republished and replaced with the updated dynamic information defined by the data structures to provide an updated second version of the web page. At box 472, the WCMS 136 again sends the second version of the web page to the production web server 104, where the updated second version is stored at box 476.

At box 480, Client2 108b requests the same web page from the production web server 104 as the web page previously requested by Client1 108a at box 430. The production web server 104 receives the request at box 484, and sends the current (or second) version of the static web page back to Client2 108b at box 488. At box 492, Client2 108b receives the second version of the static web page from the production web server 104. Although both Client1 108a and Client2 108b requested the same web page, the two static web pages served by the production web server 104 to Client1 108a and Client2 108b at boxes 440 and 488, respectively, contain different information that reflects the updated dynamic information received at box 448.

Thus, the WCMS 136 provides the functionality to proactively update one or more web pages without requiring the web server to perform any runtime determinations. Changes to the content repositories and their dynamic information is processed at the web development server 112 through the WCMS 136 before the web page is published. The processing saved by the production web server 104 can allow more clients and users to access or interact with various web pages without resulting in the runtime load typically experienced due to active components included in certain dynamic web pages.

While the present disclosure uses a plurality of flowcharts and accompanying descriptions to illustrate the example techniques associated with various methods of FIGS. 2A through 4, software environment 100 contemplates using or implementing any suitable technique for performing these and other tasks. It will be understood that these techniques are for illustration purposes only and that the described or similar techniques may be performed at any appropriate time, including concurrently, individually, or in combination. In addition, many of the steps in these flowcharts may take place simultaneously and/or in different orders than as shown and described. Moreover, software environment 100 may use processes and methods with additional, few, and/or different steps, so long as the processes and methods remain appropriate.

Although this disclosure has been described in terms of certain implementations and generally associated methods, alterations and permutations of these implementations and methods will be apparent to those skilled in the art. For example, a single web page can be associated with a plurality of content repositories, such that information from two or more repositories may be integrated into the web page in the design and then subsequently, during the design-time publishing process. In those instances, multiple queries to the plurality of content repositories will be performed during the publish and republish processes in order to retrieve all of the integrated dynamic information. In another instance, some of the published web pages may still include some dynamic content, such as shopping cart functionality associated with an online retailer. Although some dynamic content may be necessary in those instances, at least a portion of otherwise dynamic information can be incorporated into the integrated web page provided by the present disclosure such that the total number of queries is thereby reduced. Accordingly, the above description of example implementations does not define or constrain the disclosure. Other changes, substitutions, and alterations are also possible without departing from the spirit and scope of this disclosure, and such changes, substitutions, and alterations may be included within the scope of the claims included herewith.

What is claimed is:

1. Software for providing integration of static and dynamic content for an instance of a web page, the software comprising computer readable instructions embodied on tangible media and operable when executed to:
identify a content repository of structured dynamic content associated with information for a web page comprising unstructured static content;
insert a metadata data structure defining a set of the structured dynamic content into the unstructured static content of the web page to create a tag-enriched web page;
perform a publish process for the tag-enriched web page, wherein the publish process comprises:
querying the content repository for the set of structured dynamic content information defined by the metadata data structure;
populating the metadata-enriched web page with the results of the publish process query; and
storing the updated web page at a web server.

2. The software of claim 1, where the content repository of structured dynamic content comprises a database storing business data.

3. The software of claim 2, where the business data comprises product information including price information, product descriptions, and product inventory information.

4. The software of claim 1 further operable when executed to save the metadata-enriched web page in a design-time web page repository while performing the publish process.

5. The software of claim 4 further operable when executed to:
identify content updates to the content repository associated with the saved metadata-enriched web page after performing the publish process; and
perform a republish process for the metadata-enriched web page, wherein the republish process comprises:
querying the content repository for the updated set of information defined by the metadata data structure;
populating the metadata-enriched web page with the updated results; and
storing the updated web page at the web server.

6. The software of claim 5, wherein identifying content updates to the content repository comprises receiving a notification of changes to the content repository associated with the saved metadata-enriched web page.

7. The software of claim 5, wherein identifying content updates to the content repository comprises:
automatically querying the content repository at predefined intervals for results involving the set of information defined by the metadata data structure inserted in the metadata-enriched web page; and
determining whether the results of the query differ from the set of information used to populate the metadata-enriched web page.

8. The software of claim 1, where the web page consists of static content.

9. The software of claim 1, wherein the populated web page stored at the web server during the publish process comprises a first version of the web page, and further wherein the updated second web page stored at the web server during the republish process comprises a second version of the web page.

10. The software of claim 1, wherein the unstructured static content of the web page defines the presentation of the web page.

11. The software of claim 10, wherein the unstructured static content comprises hypertext markup language (HTML).

12. The software of claim 1, where the set of the structured dynamic content comprises a discrete data item.

13. The software of claim 1, where the web page is generated from a generic web page template.

14. The software of claim 13 further operable when executed to initially load the web page template from a set of one or more web page templates stored in a design-time template repository.

15. The software of claim 14, where the web page template comprise Extensible Stylesheet Language Transformations (XSLT) files.

16. The software of claim 1, where the identified content repository comprises one of a plurality of communicably coupled content repositories and the software is further operable when executed to automatically identify the appropriate content repository.

17. The software of claim 1, wherein the metadata data structure comprises a metatag.

18. A server integrating static and dynamic content for an instance of a web page being published comprising:
a memory storing a web content management system and a web page; and
one or more processors operable to:
identify a content repository of structured dynamic content associated with information for the web page comprising unstructured static content;
insert a metadata data structure defining a set of the structured dynamic content into the unstructured static content of the web page to create a tag-enriched web page;
perform a publish process for the tag-enriched web page, wherein the publish process comprises:
querying the content repository for the set of structured dynamic content information defined by the metadata data structure;
populating the metadata-enriched web page with the results of the publish process query; and
storing the updated web page at a web server.

19. The server of claim 18, where the one or more processors are further operable to save the metadata-enriched web page in a design-time web page repository while performing the publish process.

20. The server of claim 19, where the one or more processors are further operable to:
identify content updates to the content repository associated with the saved metadata-enriched web page after performing the publish process; and
perform a republish process for the metadata-enriched web page, where the republish process comprises:
querying the content repository for the updated set of information defined by the metadata data structure;
populating the metadata-enriched web page with the updated results; and
storing the updated web page at the web server.
